(19) United States
(12) Patent Application Publication
(10) Pub. No.: US 2008/0073609 A1
(43) Pub. Date: Mar. 27, 2008

(54) Compressed-air needle valve for controlling an air flow for driving engine simulators in aircraft models for wind tunnel experiments

(76) Inventor: Eldert Akkermann, Bremen (DE)

Correspondence Address: JENKINS, WILSON, TAYLOR & HUNT, P. A., 3100 TOWER BLVD., Suite 1200, DURHAM, NC, 27707, US

(21) Appl. No.: 11/901,310

(22) Filed: Sep. 17, 2007

(30) Foreign Application Priority Data
Sep. 23, 2006 (DE) 10 2006 044 996.7

(51) Int. Cl. F16K 1/06

(52) U.S. Cl. 251/121; 251/368

(57) ABSTRACT

The invention relates to a compressed-air needle valve for controlling an air flow for driving engine simulators in aircraft models for wind tunnel experiments, the needle valve including:
a housing having a front face and a rear face;
a control rod which is held in the rear face of the housing such that it can move longitudinally;
an air inlet, which is arranged in a side face of the housing;
an air outlet which is arranged in the area of a front face of the housing;
a Venturi insert upstream of the air outlet; and
a needle which is arranged at a first end of the control rod and by means of which an annular gap between the needle and the Venturi insert can be continuously varied by longitudinal movement of the control rod in order to control the air flow.

### CROSS-REFERENCE TO RELATED APPLICATIONS

This application claims the benefit of German Patent Application No. 10 2006 044 996.7 filed on Sep. 23, 2006, the complete disclosures of which are herein incorporated by reference.

### FIELD OF THE INVENTION

The invention relates to a compressed-air needle valve for controlling an air flow for driving engine simulators in aircraft models for wind tunnel experiments having a housing and having a control rod which is held in it such that it can be moved longitudinally in the area of a rear face of the housing.

### BACKGROUND OF THE INVENTION

Aircraft models for wind tunnel experiments are equipped with so-called engine simulators, for a test layout that is as realistic as possible, and these are intended to simulate the effect of the actual jet engines and/or turboprop engines of aircraft. The engine simulators are generally driven by compressed-air owing to the high rotation speed required. Complex wind tunnel models in order to simulate the flow conditions as accurately as possible on multi-jet commercial aircraft in consequence also have a number of engine simulators, corresponding to the number of jet engines or turboprop engines in the aircraft model to be simulated.

In the wind tunnel, wind tunnel models are generally suspended by means of a balance air-bridge system, with only two high-pressure air lines generally being available in order to prevent the suspension from excessively influencing the flow field in the wind tunnel. In the case of wind tunnel models with more than two jet engines or turboprop engines, it is therefore essential to integrate precise control for the engine simulators directly in the aircraft model for simulation of an aircraft, in order to allow the engine simulators to be controlled independently.

### SUMMARY OF THE INVENTION

The object of the invention is to provide a compact compressed-air needle valve for precise control of the air flow for driving such engine simulators in aircraft models for wind tunnel experiments.

This object is achieved by a compressed-air needle valve having the following features:
a housing having a front face and a rear face;
a control rod which is held in the rear face of the housing such that it can move longitudinally;
an air inlet, which is arranged in a side face of the housing;
an air outlet which is arranged in the area of a front face of the housing;
a Venturi insert upstream of the air outlet; and
a needle which is arranged at a first end of the control rod and by means of which an annular gap between the needle and the Venturi insert can be continuously varied by longitudinal movement of the control rod in order to control the air flow.

This results in the compressed-air needle valve being physically compact, allowing the compressed-air needle valve according to the invention to be integrated at least in relatively large aircraft models for wind tunnel experiments. Furthermore, the design of the compressed-air needle valve according to the invention has precise control of the compressed-air between a mass flow of 0 kg/s and 5 kg/s, with the input pressure of the air flow in the region of the air inlet of the compressed-air needle valve being up to 100 bar. The compressed-air needle valve according to the invention allows precise control of the rotation speed of engine simulators within ±50 rpm. The ingress of the needle into the Venturi insert varies the area of the annular gap between the needle and the inner surface of the Venturi insert, thus varying the mass flow of the air passing through. The rotation speed of the connected compressed-air-operated engine simulators can be controlled precisely by varying the mass flow of the air flowing through the compressed-air needle valve.

One embodiment of the compressed-air needle valve provides for a Teflon ring to be arranged between the needle and the first end of the control rod. This makes it possible to close the compressed-air needle valve completely so that, if required, it is possible to set a mass flow or air flow of 0 kg/s. For this purpose, the Teflon ring is slightly oversized, by at least 2/100 mm, in comparison to the smallest cross section of the Venturi insert. The Teflon ring on the one hand ensures that the compressed-air needle valve is completely sealed by moving the needle into the Venturi insert when the full input pressure of up to 100 bar is applied, but on the other hand also prevents mechanical damage by reducing the friction between the needle and the Venturi insert and a compressed-air needle valve sealing effect which may gradually decrease in consequence during the life.

According to another embodiment, an insert which coaxially surrounds the needle is arranged in the area of the air inlet in order to smooth the air flow. The insert or the smoother first of all smooth out or compensate for any pressure surges that occur in the air flow. Furthermore, a uniform, ideally lamellar, incident flow or surrounding flow is achieved for the needle, thus preventing the air flow, which is at high pressure, exciting needle oscillations.

According to a further embodiment, the insert is a thin-walled hollow cylinder in whose wall a multiplicity of holes are incorporated, which are arranged in the form of a grid and pass all the way through. In addition, each of the holes may be conically recessed on the inside and outside, in order to further reduce vortices in the air flow. In addition, modification of the geometric configuration of the hole pattern allows the compressed-air needle valve to be matched to different types of engine simulators for wind tunnel models. For example, the hole separation in the hole grid and/or the hole diameter itself can be varied for matching to different types of engine simulators. Furthermore, the cone angle of the recesses can be varied in some suitable manner. In addition, it is possible to vary the wall thickness of the hollow cylinder. The insert preferably has a wall thickness between 1 mm and 5 mm.

A further embodiment of the compressed-air needle valve provides for the insert to be coaxially surrounded by an annular chamber.

The provision of an annular chamber which coaxially surrounds the insert results in an air cushion, which acts as an additional buffer or store for the compressed air, and contributes to further smoothing of the air flow in the area of the air inlet.

A further embodiment provides for the first end of the control rod to have a conical surface. This prevents damage to the control rod and the inlet section of the Venturi insert when the needle is moved completely into the Venturi insert.

A further embodiment provides for a threaded hole to be incorporated at the other end of the needle. The threaded hole is used for attachment of an operating member. This embodiment allows the compressed-air needle valve to be coupled easily to standardized actuators, in particular in the form of hydraulic cylinders, compressed-air cylinders or electrical actuating elements, such as electrical-motor spindle drives.

According to a further embodiment, the air flow can be continuously variably controlled between a maximum mass flow, in particular of 5 kg/s, and a minimum mass flow of 0 kg/s. This allows precise control of the compressed-air-operated engine simulators over a wide power range, which simulates actual flight conditions very closely. Since the air flow can be decreased to a minimum value of 0 kg/s with the compressed-air needle valve completely closed, it is also possible to simulate a complete engine failure.

A further embodiment provides for the Venturi insert and the needle to be formed using a metallic material, in particular with the Venturi insert (12) being formed using bronze, and the needle being formed using stainless steel. This material combination allows the needle and the Venturi insert to be produced to extremely accurate dimensions with an acceptable degree of production effort.

Furthermore, the needle tip and the Venturi insert can be interchanged easily and at low cost for different control characteristics (fine tuning of the rotation speeds for readiness and maximum engine rotation speed for aircraft take-off simulation).

### BRIEF DESCRIPTION OF THE DRAWINGS

FIG. 1 shows a perspective external view of the compressed-air needle valve, and

FIG. 2 shows a longitudinal section through the compressed-air needle valve.

The same physical elements are each denoted by the same reference numbers in the drawing.

### DETAILED DESCRIPTION OF THE INVENTION

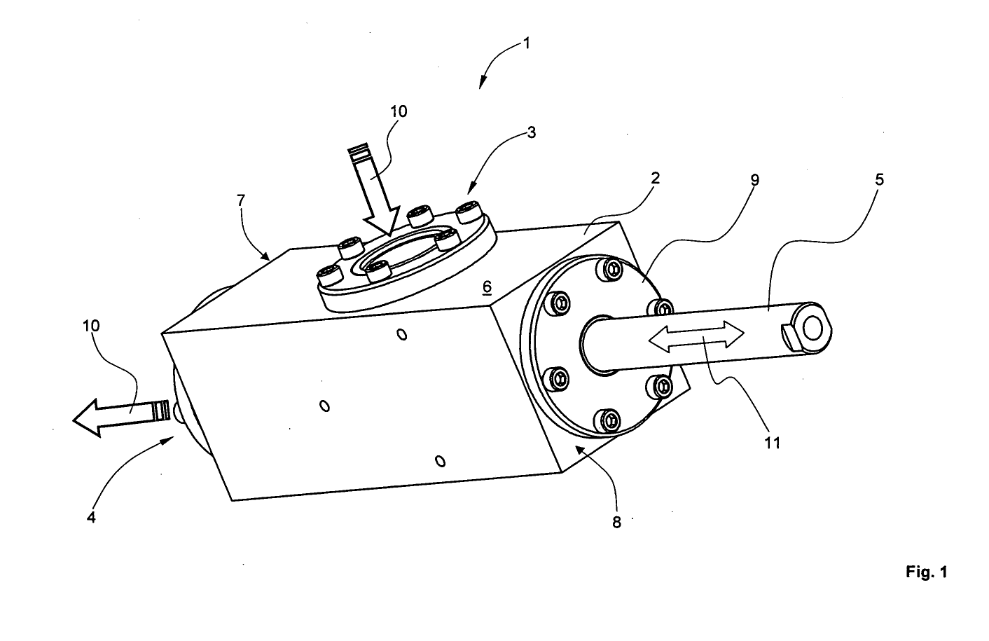

FIG. 1 shows a compressed-air needle valve 1 having an essentially cuboid housing 2, an air inlet 3 and an air outlet 4, as well as a control rod 5. The air inlet 3 is arranged in the area of a side face 6 of the housing 2, and the air outlet 4 is arranged in the area of an front face 7 of the housing 2. The control rod 5 is held in a bearing 9 such that it can move longitudinally in the area of the rear face 8 of the housing 2. An air flow 10 passes through the air inlet 3 and emerges from the air outlet 4 again from the compressed-air needle valve 1. The air flow 10 is deflected by 90° in the interior of the housing 2. In the area of the air inlet 3, the pressure of the air flow 10 is up to 100 bar. In this case, the compressed-air needle valve 1 can be used to continuously variably control an air mass flow of up to 5 kg/s between zero and its maximum value, with high accuracy, in order to drive compressed-air-operated engine simulators on wind tunnel aircraft models. The control process is carried out by insertion or removal of the control rod 5, as indicated by the double-headed arrow 11, by means of a precision linear actuating drive that is not illustrated. The rotation speed of the engine simulators can be set by means of the compressed-air needle valve 1 with an accuracy of up to ±50 rpm.

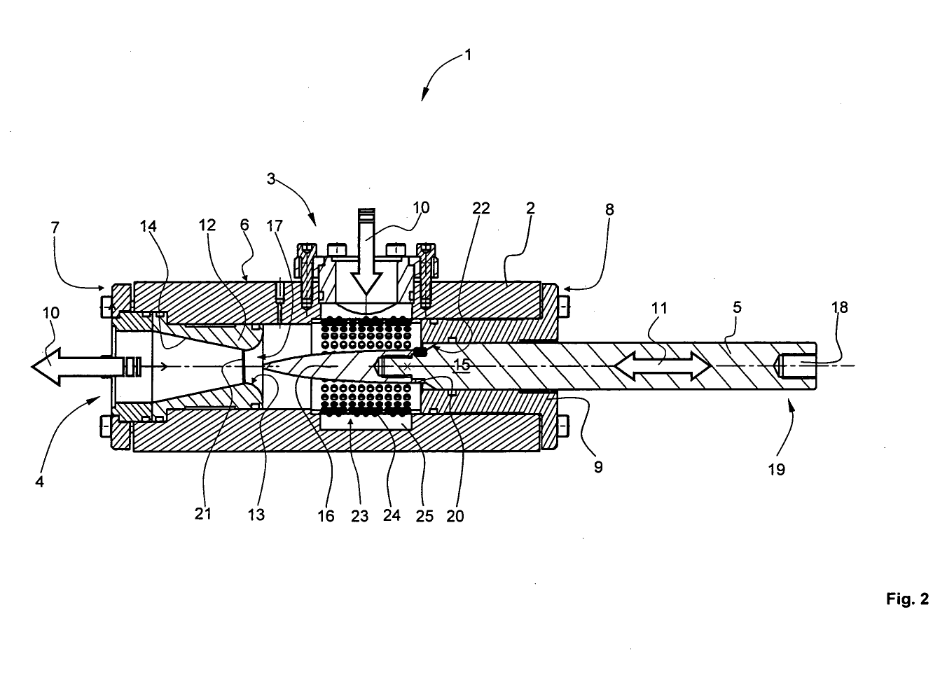

FIG. 2 shows a longitudinal section through one exemplary embodiment of the compressed-air needle valve.

The air flow 10 passes through the air inlet 3 in the side face 6 of the housing 2 into the compressed-air needle valve 1. The air outlet 4 is located in the area of the front face 7 of the housing 2. The control rod 5 is held, such that it can be moved longitudinally, in a (linear) bearing 9 which is arranged in the rear face 8 of the housing 2. The compressed-air needle valve 1 is controlled by moving the control rod 5 in the longitudinal direction, in the direction of the double-headed arrow 11.

A Venturi insert 12 is arranged in the area upstream of the air outlet 4. The Venturi insert 12 has a circular cross section which varies over its longitudinal extent. The cross section of the Venturi insert 12 tapers in an inlet section 13, while the cross section increases continuously in an outlet section 14.

A needle 16 is also attached to a first end 15 of the control rod 5. The geometric shape of the needle 16 represents, approximately, a parabolic rotational solid. There is an annular gap 17 between the needle 16 and the Venturi insert 12. The size of the annular gap 17 can be increased or decreased continuously by moving the control rod 5 in the direction of the double-headed arrow 11. This allows the air flow passing through the compressed-air needle valve 1 to be set with very high precision between 0 kg/s and 5 kg/s. In this case, the air flow 10 enters the air inlet 3 at a pressure of up to 100 bar. By way of example, the needle 16 can be mounted on the first end 15 of the control rod 5 by means of a screw thread. The control rod 5 is moved parallel to the double-headed arrow 11 in the longitudinal direction of the compressed-air needle valve 1 by means of a precision linear actuating member, which is not illustrated in FIG. 2. The precision actuating member is connected to the control rod 5 by means of a threaded hole 18, which is arranged in a second end 19.

A Teflon ring 20, a nylon ring, a polyethylene ring or the like in the form of a disc is arranged between the needle 16 and the first end 15 of the control rod 5. In order to block the compressed-air needle valve 1 completely, the needle 16 is moved into the Venturi insert 12 until the Teflon ring 20 has reached a centre section 21 of the Venturi insert 12, which has the minimum cross-sectional area in comparison to the inlet and outlet cross section 13, 14. In order to achieve a slight interference fit between the Teflon ring 20 and the centre section 21, and to increase the sealing effect, the Teflon ring 20 is slightly oversized, by up to 0.05 mm, with respect to the internal diameter of the centre section 21. The Teflon ring 20 allows the compressed-air needle valve 1 to be sealed completely, at the same time reducing wear phenomena and friction processes between the needle 16 and the Venturi insert 12. Furthermore, the control rod 5 has a conical surface 22 in the area of the first end 15, in order to prevent the control rod 5 from jamming with the Venturi insert 12. The needle 16 is preferably formed using stainless steel, while the Venturi insert 12 is composed of bronze, in order to achieve good dimensional constancy with acceptable manufacturing effort.

Furthermore, the needle 16 is coaxially surrounded by an insert 23 which, in the illustrated exemplary embodiment, is a thin-walled hollow cylinder 24. A multiplicity of holes—which are not provided with a reference number in the illustration shown in FIG. 2—are incorporated in the insert 23. The holes are arranged in the form of a matrix or a uniform grid. The holes are also recessed from an inner surface and an outer surface of the insert 23 in order to prevent the formation of vortices in the air flow 10. The insert 23 is used to smooth the air flow 10 within the compressed-air needle valve 1. Furthermore, the insert 23 is intended to ensure a uniform incident flow, which is as laminar as possible, onto all sides of the needle 16, while at the same time damping oscillation phenomena of the needle 16 resulting from the high input pressure of up to 100 bar.

The contour of the needle 16 and of the Venturi insert 12 must be calculated individually for each engine simulator to be controlled by means of the compressed-air needle valve 1. A corresponding situation applies to the design of the insert 23. By way of example, the diameter of the holes in the (smoothing) insert 23 and/or their grid separations can be varied in order to match the insert 23 to different types of engine simulators. It is also possible to vary the depth of the depressions and/or the respective countersinking angle of the holes. The wall thickness of the thin-walled hollow cylinder 24 and of the insert 23 is between 1 mm and 5 mm.

The Venturi insert 12 and the needle 16 can easily be interchanged, using standardized Venturi inserts and needles for matching to different types of engine simulators, in a simple manner. All that need be done for this purpose is to release the air inlet 3, which is flange-connected in the area of the front face 7 of the housing 2, and to remove the bearing 9, which is flange-connected to the rear face 8 of the housing 2. The needle 16 can then be unscrewed from the control rod 5 and can be replaced by a needle with a different geometric form. The Venturi insert 12 can likewise easily be removed from the housing once the air outlet 4 has been released, and can be replaced by a different one, with a different flow geometry.

The insert 23 is once again surrounded by an annular chamber 25 whose external surface is formed by the housing 2 and whose internal area, apart from the air inlet 3, corresponds essentially to the geometric shape of a hollow cylinder. The object of the annular chamber 25 is to form an air reservoir or a buffer reservoir with a relatively small volume for the air flow 10, thus contributing to further smoothing of the air flow 10 passing through the compressed-air needle valve 1.

The above-described compressed-air needle valve 1 allows accurate control of an air mass flow 10 between 0 kg/s and 5 kg/s in order to drive compressed-air-operated engine simulators. The compressed-air needle valve 1 can be used to set the rotation speed of engine simulators with an accuracy of up to ±50 rpm with an inlet air pressure of up to 100 bar. The compact design allows direct integration in aircraft models which are used for wind tunnel measurements. The insert 23 which coaxially surrounds the needle 16 and has a multiplicity of holes which are arranged in the form of a grid and pass all the way through smoothes the incident air flow onto the needle 16 and damps any oscillation phenomena in the area of the needle 16.

What is claimed is:

1. A compressed-air needle valve for controlling an air flow for driving engine simulators in aircraft models for wind tunnel experiments, the needle valve comprising:
a housing having a front face and a rear face;
a control rod which is held in the rear face of the housing such that it can move longitudinally;
an air inlet, which is arranged in a side face of the housing;
an air outlet which is arranged in the area of a front face of the housing;
a Venturi insert upstream of the air outlet; and
a needle which is arranged at a first end of the control rod and by means of which an annular gap between the needle and the Venturi insert can be continuously varied by longitudinal movement of the control rod in order to control the air flow.

2. The compressed-air needle valve according to claim 1, wherein at least one of a Teflon ring and a nylon ring is arranged between the needle and the first end of the control rod.

3. The compressed-air needle valve according to claim 1, wherein an insert coaxially surrounding the needle is arranged in the area of the air inlet in order to smooth the air flow.

4. The compressed-air needle valve according to claim 3, wherein the insert is a thin-walled hollow cylinder in whose wall a multiplicity of holes are incorporated, which are arranged in the form of a grid and pass all the way through.

5. The compressed-air needle valve according to claim 3, wherein the insert is coaxially surrounded by an annular chamber.

6. The compressed-air needle valve according to claim 1, wherein the first end of the control rod has a conical surface.

7. The compressed-air needle valve according to claim 1, wherein a second end of the control rod comprises attachment means for connection to an operating member.

8. The compressed-air needle valve according to claim 7, wherein the attachment means are constituted by a threaded hole.

9. The compressed-air needle valve according to claim 1, wherein the air flow can be continuously variably controlled between a maximum mass flow and a minimum mass flow of 0 kg/s.

10. The compressed-air needle valve according to claim 9, wherein the maximum mass flow is substantially 5 kg/s.

11. The compressed-air needle valve according to claim 1, wherein the Venturi insert and the needle are made of a metallic material.

12. The compressed-air needle valve according to claim 11, wherein the Venturi insert is made of bronze and the needle is made of stainless steel.
